(19) United States
(12) Patent Application Publication
(10) Pub. No.: US 2013/0333651 A1
(43) Pub. Date: Dec. 19, 2013

(54) DIESEL ENGINE EFFICIENCY IMPROVEMENT

(71) Applicants: Adrian James Velaers, Cape Town (ZA); Paul Werner Schaberg, Noordhoek (ZA); Andrew Yates, Knysna (ZA)

(72) Inventors: Adrian James Velaers, Cape Town (ZA); Paul Werner Schaberg, Noordhoek (ZA); Andrew Yates, Knysna (ZA)

(73) Assignee: SASOL TECHNOLOGY (PTY) LTD, Johannesburg (ZA)

(21) Appl. No.: 13/820,979

(22) PCT Filed: Sep. 6, 2011
(86) PCT No.: PCT/ZA11/00066

§ 371 Date: Sep. 3, 2013

(30) Foreign Application Priority Data
Sep. 7, 2010 (ZA) 2010/6404

(51) Int. Cl. F02B 75/12

(52) U.S. Cl. CPC F02B 75/12
USPC 123/1 A

(57) ABSTRACT

The invention provides a method of operating a diesel engine under oxygen-limited conditions such that the efficiency of the engine is at least 1% improved over the engine efficiency obtained when using a conventional crude-derived diesel fuel, said method including the combustion of a distillate fuel having a density of below 0.800 g.cm⁻³ in the engine. The invention extends to the use of a distillate fuel with a density less than 0.800 g.cm⁻³ (at 20° C.) for achieving increased engine efficiency when operating a diesel engine under oxygen-limited conditions, said use including combusting said fuel such that the efficiency of the engine is at least 1% improved over the engine efficiency obtained when using a conventional crude-derived diesel fuel.

### FIELD OF THE INVENTION

The present invention relates to suitable fuel compositions or fuel properties for diesel engines operating under oxygen-limited conditions.

### BACKGROUND OF THE INVENTION

Historically diesel engines operate at fuel-lean conditions—where fuel combustion occurs in an environment with oxidiser/air present in excess quantities to that required for stoichiometric combustion. This allows for more complete and hence efficient combustion of the diesel fuel; and partially accounts for the exceptional fuel economy of diesel engines. By contrast, rich diesel combustion typically results in reduced fuel efficiency and dramatically increased soot, unburned hydrocarbon, and CO emissions due to incomplete combustion of the diesel fuel.

Operation of diesel engines at air/fuel ratios significantly removed from the fuel-lean combustion efficiency optimum is however becoming far more prevalent for multiple reasons.

Facilitating stoichiometric or fuel-rich diesel engine operation has become a critical issue in responding to legislation evolution focussed on NOₓ emission reduction. One of the most effective technologies for exhaust NOₓ after-treatment is the LNT (Lean NOₓ Trap). This device, however, requires periodic online re-generation through exposure to exhaust reductants under very low oxygen conditions. This is obviously not easily achieved where the exhaust stream is oxygen-rich—as is the case for conventional fuel-lean diesel engine operation. Significant developments are therefore ongoing which attempt to achieve stoichiometric diesel engine operation with minimised impact on fuel efficiency. These include largely mechanical means which physically atomise the fuel or improve air-fuel mixing in order to maximise the use of the available oxygen in a fuel-rich environment.

Diesel engines operating under high load; or in high performance applications such as racing and battlefield engines, will also typically operate at conditions approaching oxygen-limited or stoichiometric operation due to the injection of excessive fuel amounts to achieve the highest possible power output. Whilst power output may be maximised in these situations, there is a significant impact on fuel efficiency in order to do so.

Additionally, diesel engines operating with significant EGR (exhaust gas recycling) in order to reduce NOₓ emissions, may also experience a reduction in fuel efficiency and increase in soot or particulate formation caused by incomplete fuel combustion.

Finally, in response to the drive to improve energy efficiency and reduce carbon dioxide emissions, vehicles are increasingly being fitted with downsized engines. This means that engines with smaller displacements, but equivalent maximum power output, are being utilised to provide similar full-load performance but with improved part-load efficiency. The smaller engine displacement means that in such engines, air availability may constrain maximum power output.

### SUMMARY OF THE INVENTION

According to a first aspect of the invention, there is provided the use of a distillate fuel with a density less than 0.800 g.cm⁻³ (at 20° C.) for achieving increased engine efficiency when operating a diesel engine under oxygen-limited conditions, said use including combusting said fuel such that the efficiency of the engine is at least 1% improved over the engine efficiency obtained when using a conventional crude-derived diesel fuel.

The improvement in engine efficiency may be 1.5%.

The improvement in engine efficiency may be 2.0% or higher.

The distillate fuel may have a density of 0.780 g.cm⁻³ or less.

The distillate fuel may have a density of 0.770 g.cm⁻³ or less.

The distillate fuel may include a Fischer-Tropsch derived diesel fuel.

According to a second aspect of the invention, there is provided a method of operating a diesel engine under oxygen-limited conditions such that the efficiency of the engine is at least 1% improved over the engine efficiency obtained when using a conventional crude-derived diesel fuel, said method including the combustion of a distillate fuel having a density of below 0.800 g.cm⁻³ in the engine.

The improvement in engine efficiency may be 1.5%.

The improvement in engine efficiency may be 2.0% or higher.

The distillate fuel may have a density of 0.780 g.cm⁻³ or less.

The distillate fuel may have a density of 0.770 g.cm⁻³ or less.

This invention appears at present to have particular application to the field of high performance applications such as racing and battlefield engines, or aggressively downsized diesel engines, but is not limited to such applications

### DETAILED DESCRIPTION OF THE INVENTION

The present invention is directed to achieving a fuel-based solution for achieving increased fuel efficiency whilst operating under conditions approaching stoichiometric or oxygen-limited operation. It has been found by the inventors that use of a Fischer Tropsch (FT) derived diesel fuel having a density of below 0.800 g.cm⁻³ results in a significant improvement in efficiency under these conditions. This may be extended to any diesel fuel with a density reduced over that observed for conventional crude-derived diesel fuels.

The diesel fuel used in the present invention will typically comprise a Fischer-Tropsch derived diesel fuel such as those described as GTL (gas-to-liquid) fuels, CTL (coal-to-liquid) fuels, BTL (biomass-to-liquids) and OTL (oil sands-to-liquid). Such distillate fuel oils typically boil within the range of from 110° C. to 500° C., e.g. 150° C. to 400° C.

Such fuels are generally suitable for use in a compression ignition (CI) internal combustion engine, of either the indirect or direct injection type.

Fischer Tropsch (FT) products cover a broad range of hydrocarbons from methane to species with molecular masses above 1400 g.mol⁻¹; including mainly paraffinic hydrocarbons and much smaller quantities of other species such as olefins and oxygenates. Such a diesel fuel could be used on its own or in blends to improve the quality of other diesel fuels not meeting the current and/or future, more stringent fuel quality and environmental specifications.

The Low Temperature FT (LTFT) process has been described extensively in the technical literature, for example in “Fischer Tropsch Technology”, edited by A P Steynberg and M Dry and published in the series Studies in Surface Science and Catalysis (v. 152) by Elsevier (2004). Some of its process features had been disclosed in, for example: U.S. Pat. No. 5,599,849, U.S. Pat. No. 5,844,006, U.S. Pat. No. 6,201,031, U.S. Pat. No. 6,265,452 and U.S. Pat. No. 6,462,098, all teaching on a “Process for producing liquid and, optionally, gaseous products from gaseous reactants”.

For this invention, the term “use” of a Fischer-Tropsch derived diesel fuel means incorporating the component into a fuel composition. This may be optionally as a blend with one or more other fuel components such as crude-derived diesel fuel. In an embodiment, the Fischer-Tropsch derived diesel fuel may be the only fuel component present, optionally with one or more fuel additives.

### Definition of Equivalence Ratio (φ) and Oxygen-Limited Conditions

The equivalence ratio of the combustion system (as used herein) is defined as the actual quotient of the fuel-to-oxidiser(air) ratio and the stoichiometric fuel-to-oxidiser(air) ratio. The equivalence ratio (φ) can therefore be expressed mathematically as:

$$φ = \frac{{m}_{fuel} / {m}_{ox}}{{( {m}_{fuel} / {m}_{ox} )}_{st}} = \frac{{n}_{fuel} / {n}_{ox}}{{( {n}_{fuel} / {n}_{ox} )}_{st}} \qquad ( Equation 1 )$$

where
m represents the mass,
n represents the number of moles,
and the suffixes are fuel (fuel) and oxidiser (ox) and stoichiometric conditions (st) respectively.

An equivalence ratio of one indicates that the amount of oxidiser or air present is exactly that required for stoichiometric combustion of the fuel present. Equivalence ratios less than one and greater than one indicate an excess or a deficiency of oxidiser relative to that required for complete combustion of the fuel, respectively.

At very low equivalence ratios, the energy released during the combustion process will be limited by the available fuel. Correspondingly, at much higher equivalence ratio values, the energy released during the combustion process can become limited by the availability of oxygen (i.e. become oxygen-limited). Oxygen-limited fuel combustion is therefore suboptimal combustion, resulting in soot formation and poor fuel efficiency. In theory, the equivalence value threshold where effective combustion ceases should be 1 i.e. all fuel is stoichiometrically combusted. However, practically this threshold will occur at somewhat lower equivalence ratio values because system or design constraints cannot enable complete use of all available oxygen in the cylinder.

The equivalence ratio value threshold where oxygen-limited operation begins is variable according to each specific diesel engine system or design. For some engine types, oxygen-limited operation may begin at phi values as low as 0.6; whilst for other, more modern engine designs, this threshold will typically be higher at values of approximately 0.8 or even 0.9.

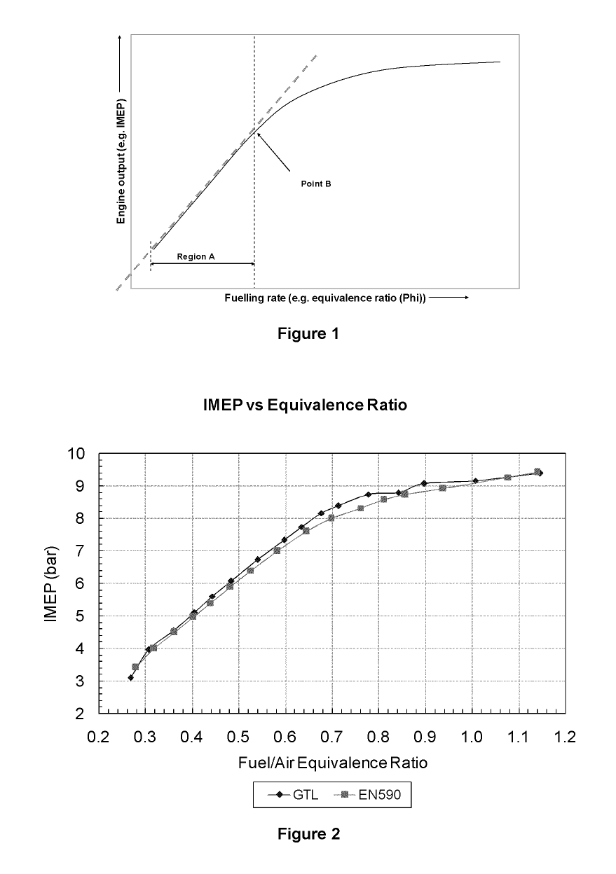

The determination of the equivalence value threshold where oxygen-limited operation begins is relatively straightforward. FIG. 1 is a schematic showing such a determination. A measurement of engine output (for example as IMEP (indicated mean effective pressure)) as a function of fuel input (for example as equivalence ratio) will show a relatively linear response under conventional operating conditions (such as that shown in region A in FIG. 1). Logically, as fuelling rate is increased, so engine output will also increase. At the point where oxygen-limited operation begins, this response will begin to indicate a reduced rate in engine output increase as a function of fuel input increase (shown as point B in FIG. 1). At higher equivalence ratios, the concentration of products of incomplete combustion (for example carbon monoxide, unburned hydrocarbons, and soot) in the exhaust gas will increase dramatically. Clearly, the fuel is no longer being combusted as effectively as was the case at lower fuelling levels (phi values). For the purposes of this invention, the threshold where this shift in behaviour is observed is defined as the oxygen-limit. Operation at equivalence ratio values in excess of this point will therefore be oxygen-limited operation.

Equivalence ratio values used within this application were determined using the measured fuel and air flow rates; and the stoichiometric fuel/air ratio which is determined from the analytically determined mass fractions of hydrogen, carbon, and oxygen in the fuel, as is known in the art (1).

### Description of Oxygen-Limited Operation Applications

Typically, oxygen-limited operation for CI diesel engines will occur in applications such as:
operation under high load i.e. fuelling in order to provide maximum power
operation optimised for high performance (such as aggressively downsized, racing, or battlefield diesel engines), also with higher levels of fuelling
operation under increased EGR conditions, which effectively reduces the amount of oxygen available for combustion
operation under stoichiometric or near stoichiometric conditions in order to utilise various NOₓ exhaust gas aftertreatment technologies

### Measurement of Engine Efficiency

According to this invention, the efficiency of the engine is improved when using an FT-derived diesel fuel under oxygen-limited conditions over that observed for crude-derived fuel under the same conditions. This efficiency is defined as the ratio of mechanical work output/fuel energy input.

“Mechanical work output” is determined by measuring engine output using methods known in the art; whilst “fuel energy input” is calculated using the calorific value of the fuel and the amount of fuel introduced for a given test. Obviously the higher the ratio value, the higher is the efficiency of the process. Efficiency in this case is therefore calculated as (nett indicated work out per cycle)/(fuel energy in per cycle), as follows:

$$Indicated Efficiency = \frac{IMEP \times {V}_{d}}{{m}_{f} \times LHV} \qquad ( Equation 2 )$$

where
IMEP is the indicated mean effective pressure in Pa
V_{d} is the cylinder swept volume in m³
m_{f} is the mass of fuel injected per cycle in kg
LHV is the lower heating value of the fuel in J/kg

This efficiency improvement can be measured relative to a base case using a crude-derived diesel fuel such as fuel meeting the European EN590 diesel fuel specification. As oxygen-limited conditions are approached, a positive efficiency differential is observed when using the FT-derived diesel fuel. Typically, this improvement is at least 1% to 2.0% relative to the crude-derived fuel efficiency measurement under the same conditions.

The invention will now be illustrated by the following non-limiting example:

### Example

Engine testing was carried out over a range of air/fuel conditions using two test fuels:
GTL, a fully-synthetic FT-derived diesel; and
EN590, a representative crude-derived reference European diesel.

TABLE 1
Properties of test fuels

| | | Crude-derived diesel | FT diesel |
|---|---|---|---|
| Fuel property | Unit | EN590 | GTL |
| Density @ 20° C. | g · cm⁻⁶ | 0.8297 | 0.7647 |
| Flashpoint | ° C. | 60 | 63 |
| Viscosity @ 40° C. | cSt | 2.73 | 2.46 |
| CFPP | ° C. | −8 | −5 |
| Sulphur content | ppm | <10 | <1 |
| Cetane number | | 54.8 | >74 |
| Carbon content | Mass % | 86.2 | 85.0 |
| Hydrogen content | Mass % | 13.8 | 15.0 |
| Total aromatic content | Mass % | 27.9 | 0.14 |
| Lower heating value | MJ/kg | 42.75 | 43.81 |

Engine testing was conducted on a Ricardo Hydra single cylinder research engine which was configured to resemble a modern passenger car diesel engine.

TABLE 2
Hydra engine specifications

| Engine parameter | Unit | Value |
|---|---|---|
| Bore | mm | 80.26 |
| Stroke | mm | 88.90 |
| Swept volume | cm³ | 450 |
| Compression ratio | | 16:1 |
| Fuel injection system | | Common rail - DI |

The test procedure involved running the engine under stable conditions and gradually increasing the injection duration. A fast data acquisition and statistical averaging system was used to record the results at each test point.

TABLE 3
Engine test settings
Test Point

| | | | | | | | | | | | | | | | | | | |
|---|---|---|---|---|---|---|---|---|---|---|---|---|---|---|---|---|---|---|
| 1 | 2 | 3 | 4 | 5 | 6 | 7 | 8 | 9 | 10 | 11 | 12 | 13 | 14 | 15 | 16 | 17 | 18 | 19 |

Injection Duration (μs)

| | | | | | | | | | | | | | | | | | | |
|---|---|---|---|---|---|---|---|---|---|---|---|---|---|---|---|---|---|---|
| 400 | 425 | 450 | 475 | 500 | 525 | 550 | 575 | 600 | 625 | 650 | 675 | 700 | 800 | 900 | 1000 | 1100 | 1200 | 1300 |

| | | |
|---|---|---|
| Engine Speed | rpm | 2400 |
| Injection Timing | ° BTDC | 12 |
| Rail Pressure | bar | 1000 |
| Manifold Pressure | bar | atmospheric |
| Manifold Temperature | ° C. | 50 |
| Water Temperature | ° C. | 85 |
| Oil Temperature | ° C. | 110 |
| Fuel Temperature | ° C. | 20 |

The performance of the FT-derived GTL diesel was then compared to an EN590 reference diesel.

An analysis of the results showed that the region of interest showing differential behaviour between the two samples was in the range between 500 and 700 μs injection duration. This can be considered as approaching oxygen-limited conditions. Further testing was done to provide more data points in this region to facilitate the curve-fitting presented in the results.

Engine output was measured in two independent ways:
torque was measured by a load cell on the dynamometer; and
an in-cylinder pressure transducer (type AVL Q34C) provided a signal from which the IMEP (indicated mean effective pressure) was calculated.

These IMEP and torque results can therefore be considered to represent two independent measurements of engine output. Both are averaged over 88 cycles of the engine running at stable conditions.
IMEP can also be calculated from the torque values and hence cross-checked.
Fuel consumption was measured on a mass basis using a calibrated fuel balance (model AVL 733) and converted to volume at 20° C. using the fuel density.
Air consumption was measured by means of a calibrated laminar flow meter (model Cussons 1202)
Energy-in represents the fuel energy injected during each cycle and is based on the engine speed, fuel mass flow rate and the energy content of the fuel.

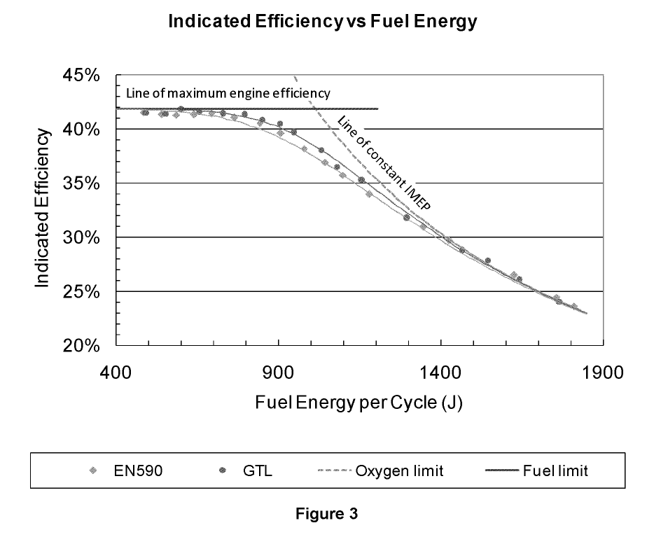

The results for certain measurements obtained from this study are graphically presented in FIG. 2 and FIG. 3.

FIG. 2 shows the IMEP (as a measure of engine output) as a function of the equivalence ratio value. The existence of a common maximum IMEP with increasing equivalence ratio value is evident for both fuel samples. There is also a clear difference between the behaviour of the GTL diesel and the EN590 reference diesel when the equivalence ratio increases beyond approximately 0.6 in this example. This difference grows more significant as the equivalence ratio value increases above 0.7 and then decreases as the value exceeds 1. It can be seen quite clearly that, as operating conditions become more oxygen-limited, the engine output when using GTL diesel significantly exceeds that of the reference crude-derived EN590 diesel.

In order to directly confirm this difference in behaviour; and account for any effects that could be attributed to differences in fuel properties (such as density, calorific value, equivalence ratio etc.) between the two samples; a means of equitably comparing performance data for each sample was employed.

The fuel energy input (in J) for each test point can be calculated from the fuel mass flow rate and engine speed for that point, and the lower heating value of the fuel (LHV, in MJ/kg), as follows:

$$fuel energy in = \frac{{\dot{m}}_{f} \times LHV}{30 N} \qquad ( Equation 3 )$$

Where
\dot{m}_{f} is the fuel mass flow rate in kg/h
LHV is the fuel lower heating value in J/kg
N is the engine rotational speed in rev/min

If the efficiency of the engine can be broadly defined as (work out)/(energy in); then equally, the indicated efficiency for any given point can be calculated (according to Equation 2 above). It is hence possible to plot a graph of engine indicated efficiency as a function of fuel energy input (according to Equation 3), as is shown in FIG. 3.

Where the energy input is low (i.e. at low fuelling levels), the data for both fuel samples falls approximately along a straight line representing the maximum engine efficiency at that operating point. This is shown in FIG. 3 as a horizontal line showing constant efficiency. Combustion efficiency is maximised in this region because there is plenty of excess air in the cylinder.

With increasing fuel energy input (\dot{m}_{f}.LHV) (i.e. as the fuelling level is increased), so the available oxygen in the cylinder becomes limiting, and combustion efficiency reduces as does the overall engine efficiency. Eventually these points will fall along a hyperbola depicting the efficiency at a constant IMEP. This can be considered the oxygen-limited maximum output of the engine as no increase in IMEP is realised for more energy (i.e. fuel) added.

The interesting result observed in this application lies in the transition between these two boundary conditions. Any difference in the efficiency results of the two fuels in this region indicates a difference in combustion efficiency between the two fuels. The closer the fuel efficiency curve gets to the intersection of the fuel limit and oxygen limit lines, the higher is the combustion efficiency property of the fuel. Again, it is very evident in FIG. 3, that GTL diesel gives a significant performance advantage over the crude-derived reference as oxygen-limited conditions are approached. The curves fitted to the data show the maximum efficiency advantage of GTL diesel over EN590 diesel to be approximately 2.4% for these test results. This appears to indicate that GTL diesel makes more effective use than EN590 diesel of the air available in the cylinder as oxygen-limited conditions are approached. This is in agreement with the conclusions drawn from FIG. 2.

### REFERENCES

(1) J. B. Heywood, Internal Combustion Engine Fundamentals, McGraw Hill, 1988, pg 69.

1-11. (canceled)

12. A method of operating a diesel engine, comprising:
combusting a distillate fuel with a density less than 0.800 g.cm³ (at 20° C.) in a diesel engine under oxygen-limited operating conditions.

13. The method of claim 12, wherein the distillate fuel has a density of 0.780 g.cm³ or less.

14. The method of claim 12, wherein the distillate fuel has a density of 0.770 g.cm³ or less.

15. The method of claim 12, wherein the distillate fuel comprises a Fischer-Tropsch diesel fuel as a component thereof.

16. The method of claim 15, wherein the distillate fuel is a Fischer-Tropsch diesel fuel.

17. The method of claim 12, wherein an efficiency of the engine is improved when compared to an efficiency of the engine when a conventional distillate fuel is combusted.

18. The method of claim 17, wherein the distillate fuel has a density of 0.780 g.cm³ or less.

19. The method of claim 18, wherein the distillate fuel has a density of 0.770 g.cm³ or less.

20. The method of claim 17, wherein the distillate fuel comprises a Fischer-Tropsch diesel fuel as a component thereof.

21. The method of claim 20, wherein the distillate fuel is a Fischer-Tropsch diesel fuel.

22. The method of claim 17, wherein an efficiency of the engine is improved by at least 1.5% when compared to an efficiency of the engine when a conventional distillate fuel is combusted.
